(19) United States
(12) Patent Application Publication
(10) Pub. No.: US 2008/0245816 A1
(43) Pub. Date: Oct. 9, 2008

(54) Tap with Foil-Piercing Device for Liquid Containers

(75) Inventors: Gavin Armstrong, Suffolk (GB); Terence Paul Waite, Middlesex (GB)

Correspondence Address: WOOD, HERRON & EVANS, LLP, 2700 CAREW TOWER, 441 VINE STREET, CINCINNATI, OH, 45202, US

(73) Assignee: DS SMITH PLASTICS LTD., London (GB)

(21) Appl. No.: 11/908,751

(22) PCT Filed: Mar. 13, 2006
(86) PCT No.: PCT/GB2006/000895

§ 371 Date: Jun. 9, 2008

(30) Foreign Application Priority Data
Mar. 15, 2005 (GB) 0505304.6

(51) Int. Cl. B67D 5/00; B67D 3/00

(52) U.S. Cl. 222/81; 222/518

(57) ABSTRACT

A tap 2 is provided which has a body with an inlet 8 and an outlet 10, valve means to control fluid flow from the inlet 8 to the outlet 10, seal opening means 14 designed either to pierce a sealing diaphragm or to open a sealing plug and actuation means 12, 48 for actuating the seal opening means 14. The seal opening means 14 comprises a seal opening member 16 coupled to a spring member which in an initial position is in a compressed state. The actuation means 12, 48 actuates the seal opening means 14 by releasing the spring member 18 from the compressed state such that the spring member 18 then drives the seal opening member 16 to open the seal.

This invention relates to taps of the kind used with bulk containers for liquid.

Bulk containers made from flexible material have become increasingly popular for the storage and marketing of beverages, in particular wine, fruit juices and dairy products. Taps for such flexible bulk containers are often required to rupture a portion thereof on first operation to allow dispensing of the contents of the container.

Whether or not the container is flexible, when it is to be used to carry liquids such as wine, fruit juices and dairy products which deteriorate in storage due to the ingress of oxygen and/or microbiological agents, the container or tap is often provided with a seal for preventing ingress and the tap is arranged to open the seal on first operation.

One known form of tap is designed to be attached to a wall of the container and to rupture part of that wall. In a second known arrangement, the container is provided with a socket mounted in the wall thereof which includes a flexible membrane for sealing the container. The tap is attached to the socket and is arranged to rupture the flexible membrane on first operation thereof. In a third known arrangement, the tap is also mounted in a socket attached to the wall of the container, but the membrane to be pierced is sealed over the inlet portion of the tap body itself.

A known alternative to provision of a flexible membrane is a sealing plug which seals an opening in the container and is removed by the tap on first operation of the tap.

British Patent Applications 2096284 and 2263693 describe taps of the above discussed type in which the valve means comprises a valve member biased to its closed position by a manually compressible cap which is referred to as a push button. The tap can be arranged such that the push button is pressed generally downwardly in order to move the valve member to the open position and as a result such taps are often termed “top push” taps. Alternatively, the push button can be arranged so that it is pressed towards the front of the container in a general horizontal movement and such taps are often termed “front push” taps.

Whilst taps having push buttons are preferred because they are self-closing and better valving is achieved, taps with other arrangements for moving the valve member are known. In one such tap, the cap is threaded on the tap body and the valve member is moved by rotating the cap relative the tap body.

In all known arrangements, before first actuation, be it by pressing a push button or by rotating an end cap to follow a threaded path, the seal opening means is stored within the tap in a stable, low energy state. On first manual actuation, simple mechanical action causes either a piercer to move slowly forward to pierce the flexible membrane or removal of the plug. The applied force and rate of movement is dependent on the manual action.

Ideally, after first actuation, the piercer should remain in an extended position in order to hold the pierced membrane edges away from the flow path so as to maintain good flow. Similar considerations apply with respect to a plug. This means that the piercer or plug needs to be stopped from floating forward into the container or back into the tap, which is achieved by providing another part of the tap as a latch. This requirement, together with the need to limit projection of the tap from the container when set up for dispensing, tends to limit the protrusion distance of the piercer from the tap backend. In current commercial systems, this distance is typically 8-10 mm.

As a result, current taps have suffered from unreliable piercing or unplugging performance, the former particularly so with more extensible membranes.

In accordance with the invention, there is provided a tap having a body with an inlet and an outlet, valve means to control fluid flow from the inlet to the outlet, seal opening means designed either to pierce a sealing diaphragm or to open a sealing plug and actuation means for actuating the seal opening means, wherein the seal opening means comprises a seal opening member coupled to a spring member which in an initial position is in a compressed state, the actuation means actuating the seal opening means by releasing the spring member from the compressed state such that the spring member then drives the seal opening member to open the seal.

In such a tap, the seal opening member, whether it be a piercer or a plug, is held initially by the compressed spring member. On actuation the spring force is released and the seal opening member is moved with high momentum which results in much more efficient piercing or unplugging.

The seal opening member may comprise a stem and a piercing head having at least one piercing protrusion or it may comprise a stem having the sealing plug formed in its head. In either case the spring member preferably comprises at least one spring element, the or each spring element having the form of a plate or elongate strip of resilient material. This form of spring member is readily manufactured and has been found to be very effective.

The spring element may be connected to the seal opening member via a hinge. This facilitates assembly of the seal opening member and spring member within the tap body and positioning of the spring member in the compressed state.

In one embodiment the spring member and the seal opening member are integral. This has the advantage of reducing the number of parts of the tap overall and also facilitates manufacturing and assembly.

The tap may have restraint means for holding the spring member in the compressed state until actuated by the actuation means. In one particularly preferred embodiment the restraint means comprises interengaging restraint members which are disengaged by the actuation means.

The tap may also comprises stop means for fixing the seal opening member relative the tap body following actuation. This ensures good flow without interference from the seal opening member or the flexible membrane in the case where the seal opening member is a piercer.

In one preferred embodiment, the stop means comprises the spring member, whilst in another the stop means comprises a separate stop member arranged to engage the spring member and hold it and the seal opening member against movement.

The valve means may comprise a valve member and a drive means for moving the valve member relative either the inlet or the outlet. Preferably the drive means comprises the actuation means.

The invention is particularly effective when the tap is of the top push type. It has been found possible to extend the protrusion distance to 15 mm without compromising the overall tap projection from the container. This gives reliable piercing even with more extensible films.

Whatever the form of the tap, it operates by releasing stored energy which is wholly different from known taps including, in particular, that of British Application 2096284.

The invention will now be further described by way of example with reference to the accompanying drawings in which:

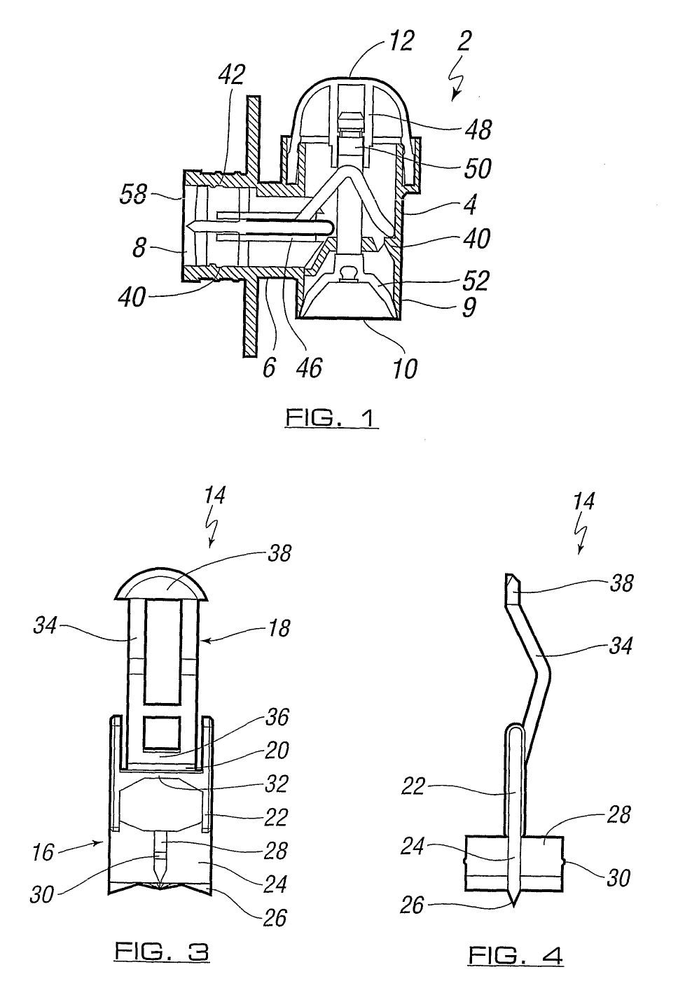

FIGS. 1 is a side sectional view of a tap in accordance with the invention prior to use;

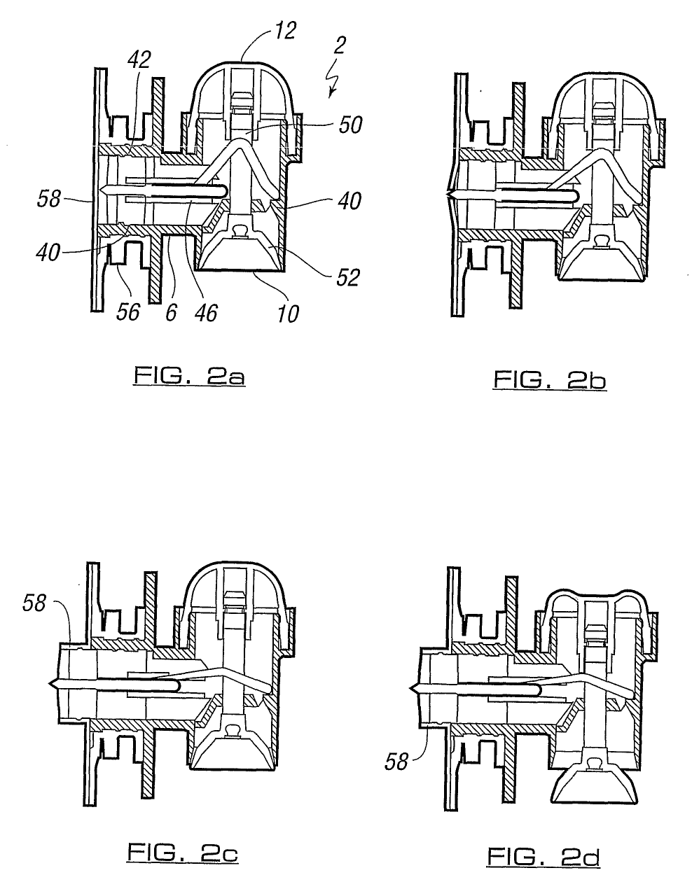

FIGS. 2A to D are side sectional views of a variant of the tap of FIG. 1 illustrating operation of the tap;

FIG. 3 is a plan view of seal opening means of the tap of FIGS. 1 and 2;

FIG. 4 is a side view of the seal opening means of FIG. 3;

FIG. 5 is a side sectional view of a variant of the tap of FIG. 1 showing operation of the tap;

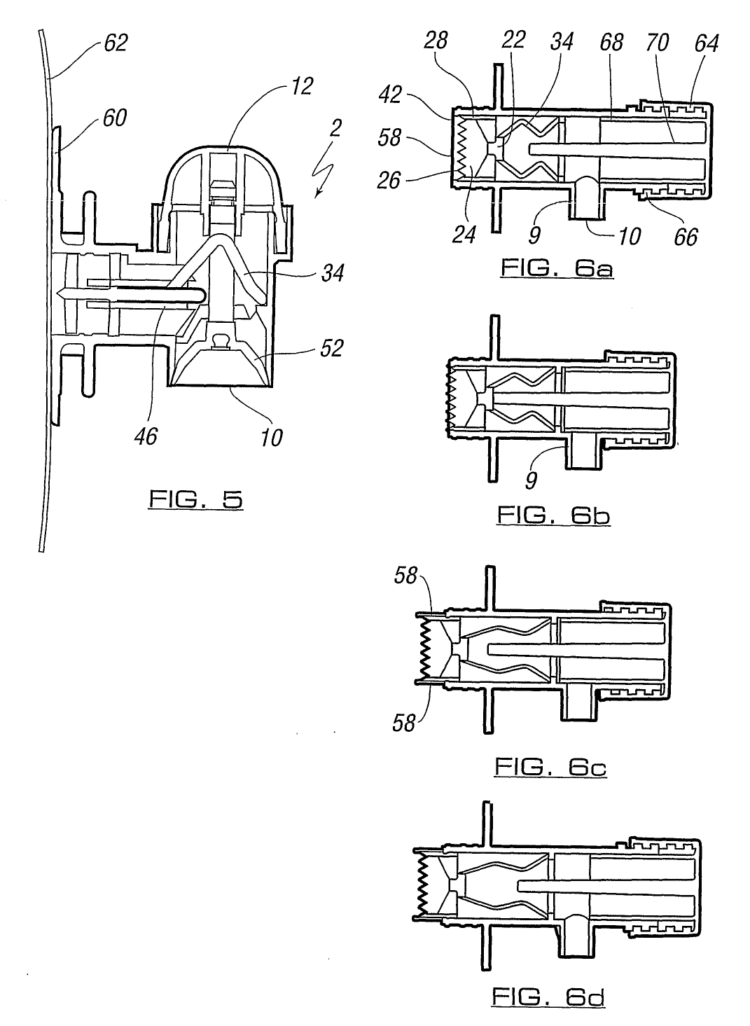

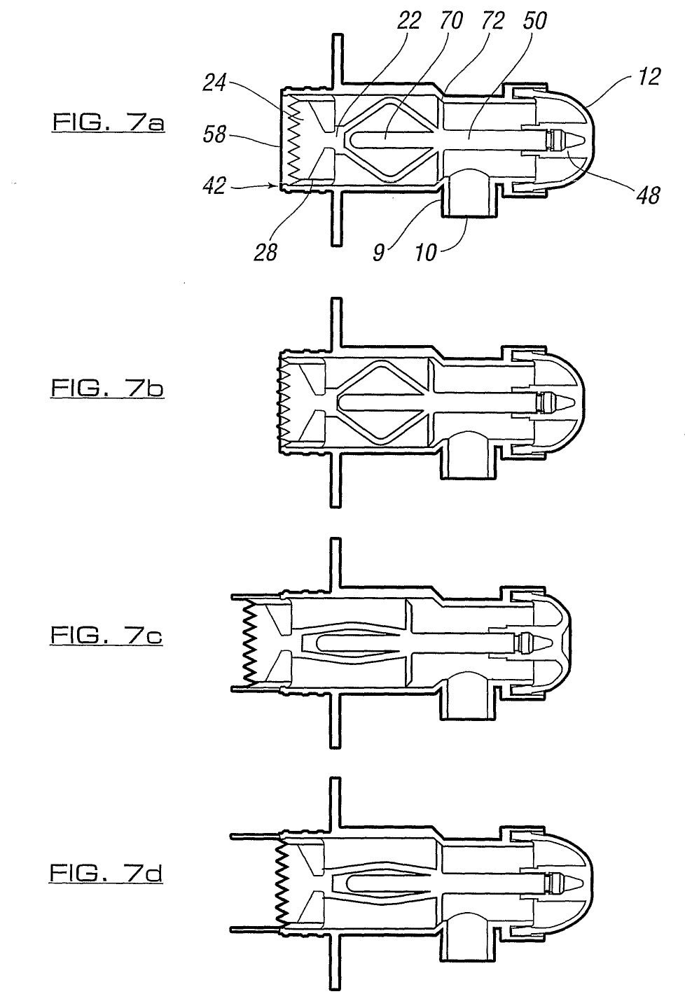

FIGS. 6A to D are side sectional views of another embodiment of a tap in accordance with the invention, and,

FIGS. 7A to D are side sectional views of a further embodiment of the tap in accordance with the invention.

The tap 2 shown in FIG. 1 is of the top push type. It comprises a body 4 having an inlet portion 6 terminating in an inlet 8 and an outlet portion 9 terminating in an outlet 10. The body 4 extends above the outlet 10 and is closed at its other end by a resilient cap or push button 12.

The body 4 may be formed from any suitable material such as high-density polyethylene, low-density polyethylene, linear low-density polyethylene. The push button 12 needs to be resilient but flexible so that it is capable of large deformation under manual pressure but subsequently resuming its original shape when the pressure is removed. The push button 12 is suitably formed from an elastomeric polymer, for example, ethylene vinyl acetate or modified polybutyleneterephthalate.

The tap 2 includes a seal opening means 14 shown in FIGS. 3 and 4. The seal opening means 14 comprises a seal opening member 16 and a spring member 18 which are coupled via a hinge 20. The seal opening member 16 has a bifurcated stem 22 carrying a head 24 formed with piercing protrusions 26. The head 24 is also formed with two cross members 28, each of which carries a lug 30, the purpose of which will be described hereinafter.

The forked stem 2 of the seal opening member 16 has a crosspiece 32 to which the spring member 18 is connected via hinge 20. As illustrated, the seal opening member 16, spring member 18 and hinge 20 are all preferably integral.

The spring member 18 comprises two spring elements 34, each in the form of a strip and connected at one end to a crosspiece 36 which in turn is connected to hinge 20. At their other ends the spring elements 34 are connected to a cross plate 38. As illustrated in FIG. 4, the spring elements 34 in an unstressed state are curved out of the plane defined by the fork stem 22 and head 24 of the seal opening member 16.

At least the spring member 18, but also the seal opening member 16 and hinge 20 when these are integral, is formed from a resiliently flexible elastic material which is such as to allow the spring elements 34 to be compressed to the state illustrated in FIG. 1 where the curve of the spring elements 34 is increased. This is achieved on assembly of the tap 2 by locating the cross plate 38 against the tap body 4 above a ledge 40 integrally formed therewith and then pressing the head 24 of the seal opening member 16 into the inlet portion 6 until the lugs 30 engage behind interference beads 42 provided within the inlet portion 6. The engagement of the lugs 30 with the interference beads 42 then holds the spring elements 34 in the compressed state extending upwardly into the push button 12.

As can be seen in FIG. 1, the tap body 4 is formed with a pair of slides 46 on either side of the inlet portion 6. When the seal opening means 14 is assembled in the tap 2, each pair of slides 46 receives one of the forks of the stem 22 of the seal opening member 16 therebetween. The pairs of slides 46 act as guides for the stem 22 and hence the seal opening member 16.

The push button 12 has a stem 48 extending down from the concave surface thereof. The stem 48 is formed with a socket for receiving the upper end of a valve shaft 50. At its other end the valve shaft 50 carries a valve member 52 which engages with the tap body 4 to seal the outlet 10. Manual pressure on the pushbutton 12 causes the stem 48 and hence the valve shaft 50 and valve member 52 to move downwardly to open the outlet 10.

When the seal opening means 14 is assembled in the tap 2, the two spring elements are positioned on either side of the valve shaft 50. The spacing between these spring elements 34 is such as to allow the valve shaft 50 to move up and down therebetween. The arrangement is also such that the ends of the spring elements 34 are located just below or in contact with the bottom end of the stem 48 of the push button 12.

The tap 2 in the pre-use position of FIG. 1 is mounted to a container as illustrated in FIG. 2A. The inlet portion 6 is arranged to be received in a socket 54 fitted into a container (not shown). Either the socket 54 supports a flexible membrane 58 across the inlet 8 as shown in FIG. 2A or the flexible membrane 58 is affixed to the inlet portion 6 of the tap 2 across the inlet 8 as shown in FIG. 1.

Commencing from the pre-use position of FIG. 2A, when manual pressure is applied to the push button 12, the stem 48 descends and engages the spring elements 34. The spring elements 34 move downwardly and apply pressure on the seal opening member 16 which therefore moves towards the container to bring the piercing protrusions 26 into contact with the diaphragm 58 as shown in FIG. 2B.

The movement of the seal opening member 16 causes the lugs 30 to be disengaged from the interference beads 42. This releases the spring elements 34 which therefore drive the seal opening member 16 into the container which causes the piercing protrusions 26 to fully rupture the sealing diaphragm 58. The seal opening member 16 is guided throughout by the slides 46.

Further pressure on the push button 12 causes the valve shaft 50 and hence the valve member 52 to descend sufficiently to open the outlet 10 as illustrated in FIG. 2D.

The seal opening member 16 is prevented from floating into the container by the valve stem 50 which will act as a stop for the cross plate 38. Using the valve stem 50 as the stop enables an increase in the degree of protrusion of the head 24 of the seal opening member 16 from the tap back end to 15 mm without resulting in an increase in the degree of projection of the tap 2 from the container edge. This increased degree of protrusion in comparison with known systems ensures that diaphragms formed even from quite extensible films are pierced. It also improves the efficiency of piercing.

The spring force provided by the spring member 18 can be customised to suit piercing force requirements and economic considerations by a choice of material as well as angle, thickness and length of the spring elements 34.

FIG. 5 shows a variant of the tap 2 of FIGS. 1 and 2 in which the inlet portion 6 is formed with an annular flange 60 which allows the tap 2 to be adhered directly to a flexible diaphragm 62 which may be part of the wall of a flexible container. This avoids the need for a socket. The elements of the tap 2 of FIG. 5 are otherwise identical to those of the tap 2 of FIGS. 1 and 2 and it operates in the same way.

FIGS. 6A to D show a tap 2 which is operated from the front rather than the top. The tap 2 has a number of features in common with the top push tap of FIGS. 1 to 5 and like numerals will be used for like parts.

The tap 2 of FIGS. 6A to D does not have a push button 12. Instead the tap 2 is closed and operated by an end cap 64 which is threaded, see 66, to the tap body 4. The end cap 64 has a cylindrical flange 68 which slidingly engages the tap body 4 and is moved by rotation of the end cap 64 across the outlet portion 9 to open and close the outlet 10. The end cap 64 also carries a rod 70 which extends towards the inlet 8, the purpose of which will be described hereinafter.

As with the tap 2 of FIG. 1 to 5, the seal opening member 16 of the tap 2 of FIG. 6 has a head 24 formed with piercing protrusions 26 and cross members 28. The cross members 28 do not however carry lugs and the stem 22 of the seal opening member is very much shorter and not bifurcated. The shortened stem 22 is integrally connected to the spring elements 34, the connection points effectively providing a hinge between the stem 22 and each spring element 34.

The spring elements 34 extend from the connection points to the stem 22 on opposite sides of the axis of the stem 22 and have a generally Z-shape. The free ends of the spring elements 34 are secured to the tap body 4 against ledges 40.

In the pre-use position illustrated in FIG. 6A, the front ends of the cross members 28 engage behind interference beads 42 provided at the front of the inlet portion 6 adjacent the inlet 8. In this position the piercing protrusions 28 are spaced from the diaphragm 58. The end cap 64 is located relative the tap body 4 such that the outlet 10 is open.

From this position, the end cap 64 is rotated relative the tap body to bring the cylindrical flange 68 to a position where it closes the outlet 10. As illustrated in FIG. 6B, the rod 70 is thereby brought into contact with the stem 22 of the seal opening member 16 and moves the seal opening member 16 towards and into engagement with the diaphragm 58. This causes the ends of the cross members 28 to disengage from the interference beads 42 which in turn releases the spring elements 34. As illustrated in FIG. 6C, the result is that the seal opening member 16 is driven forwards by the spring elements 34 which causes the piercing protrusions 26 to fully rupture the sealing diaphragm 58. Liquid from the container will then enter the tap 2 but is prevented from exiting by virtue of the fact that the outlet 10 is closed.

The seal opening member 16 is prevented from floating into the container by the connection between the spring elements 34 and the tap body 4.

The tap 2 is then ready for dispensing. This is achieved by moving the end cap 64 to the initial position relative the body 4 which opens the outlet 10 as shown in FIG. 6D.

FIGS. 7A to D illustrate a tap 2 which like the tap of FIGS. 6A to D is operated from the front. The tap 3 of FIGS. 7A to D is however a front push tap, that is, the tap 2 is closed and operated by a push button 12 rather than a threaded end cap. In consequence a different valving system is provided. Rather than the outlet 10 being opened and closed by a cylindrical flange, the tap 2 of FIGS. 7A to D like that of FIGS. 1 to 5 has a valve member 52 carried on a valve shaft 50. The tap body 4 is shaped to provide a valve seat 72 adjacent the outlet portion 9 for engagement by the valve member 52.

The valve shaft 50 extends beyond the valve member 52 to provide actuation rod 70. As with the tap 2 of FIGS. 6A to D, the spring elements are again positioned on either side of the axis of the stem 22 of the seal opening member 16 and hence on either side of the actuation rod 70. However, the spring elements 34 do not have a Z cross-section and instead take a similar shape to those of the tap 2 of FIGS. 1 to 5. Furthermore, the spring elements 34 extend from the stem 22 to the actuation rod 70 and are joined to that rod 70 adjacent the valve member 52.

Like the tap 2 of FIGS. 6A to D, the inlet portion 6 of the tap 2 of FIGS. 7A to D has interference beads 42 for engagement by the cross members 28 to restrain the seal opening member 16 and spring member 18 in the initial pre-use position of FIG. 7A. In that position, the piercing protrusions 28 are spaced from the diaphragm 58 and the valve member 52 engages with the valve seat 72 so that the outlet 10 is closed.

When the push button 12 is pressed, the valve stem 50 and actuation rod 70 move towards the container. This lifts the valve member 52 off the valve seat 72 and brings the seal opening member 16 into engagement with the diaphragm 58. The ends of the cross members 28 press against the interference beads 42 which in this tap are arranged to be frangible and to break away under the pressure of the ends of the cross members 28.

As illustrated in FIG. 7C, the spring elements 34 are released by breaking off of the interference beads 42 and therefore drive the seal opening member 16 forwards causing the piercing protrusions 26 to fully rupture the sealing diaphragm 58. Liquid from the container will then enter the tap 2 and can exit via the outlet 10. Thus, in this tap, the piercing action also involves dispensing.

The tap 2 is closed by releasing the pressure on the push button 12 which causes the seal member 52 to be drawn back into engagement with the valve seat 72. As will be seen from FIG. 7D, the seal opening member 16 retracts back into the inlet portion 8. However, as the interference beads 42 have been broken off, there is no risk of restraint of the seal opening member which might interfere with subsequent operation of the valve.

With both the tap 2 of FIGS. 6A to D and that of FIGS. 7A to D, the seal opening member is prevented from floating into the container by the spring elements 34 because these are connected to the tap body 4 in the case of the tap of FIGS. 6A to D and to the valve member 52 in the case of the tap of FIGS. 7A to D.

Although both the taps 2 of FIGS. 6A to D and 7A to D are provided with an actuation rod 70, this is not essential. Provision of an actuation rod 70 helps ensure efficient piercing action but the rod 70 could be dispensed with and the opening force transmitted to the seal opening member 16 just by the spring elements 34.

It will also be appreciated that the spring elements 34 can take forms other than those of the above described embodiments. Still further, it will be appreciated that different valving systems can be employed dependent amongst other things on the way in which the tap is operated and whether it is the inlet or the outlet which is to be sealed. For example, it may be possible to arrange the front operated taps of FIGS. 6 and 7 such that the valve member is provided on the head of the seal opening member.

1. A tap having a body with an inlet and an outlet, a valve apparatus adapted to control fluid flow from the inlet to the outlet, seal opening mechanism adapted either to pierce a sealing diaphragm or to open a sealing plug, and an actuation component adapted to actuate the seal opening mechanism, wherein the seal opening mechanism comprises a seal opening member coupled to a spring member which in an initial position is in a compressed state, the actuation component actuating the seal opening mechanism by releasing the spring member from the compressed state such that the spring member then drives the seal opening member to open the seal.

2. A tap as claimed in claim 1 wherein the seal opening member comprises a stem and a piercing head having at least one piercing protrusion.

3. A tap as claimed in claim 1 wherein the seal opening member comprises a stem having the sealing plug formed on its head.

4. A tap as claimed in claim 1 wherein the spring member comprises at least one spring element, the or each spring element having the form of a plate or elongate strip of resilient material.

5. A tap as claimed in claim 4 wherein the spring element is connected to the seal opening member via a hinge.

6. A tap as claimed in claim 4 wherein the spring member and the seal opening member are integral.

7. A tap as claimed in claim 1 further comprising a restraint mechanism adapted to hold the spring member in the compressed state until actuated by the actuation component.

8. A tap as claimed in claim 7 wherein the restraint mechanism comprises interengaging restraint members which are disengaged by the actuation component.

9. A tap as claimed in claim 1 further comprising a stop adapted to limit movement of the seal opening member relative the tap body following actuation.

10. A tap as claimed in claim 9 wherein the stop comprises the spring member.

11. A tap as claimed in claim 9 wherein the stop comprises a stop member arranged to engage the spring member and hold it and the seal opening member against movement.

12. A tap as claimed in claim 1 wherein the valve apparatus comprises a valve member and a drive member adapted to move the valve element relative either the inlet or the outlet.

13. A tap as claimed in claim 12 wherein the drive member comprises the actuation component.

14. A tap as claimed in claim 12 wherein the drive member is operated from the front or the top of the tap.

15. A tap as claimed in claim 13 wherein the drive member is operated from the front or the top of the tap.
